(19) United States
(12) Patent Application Publication
(10) Pub. No.: US 2026/0145656 A1
(43) Pub. Date: May 28, 2026

(54) BRAKING SYSTEM AND CONTROL METHOD

(71) Applicant: Continental Automotive Technologies GmbH, Hannover (DE)

(72) Inventors: Vandit Goyal, Kriftel (DE); Alexander Teut, Frankfurt (DE)

(73) Assignee: Continental Automotive Technologies GmbH, Hannover (DE)

(21) Appl. No.: 19/374,739

(22) Filed: Oct. 30, 2025

(30) Foreign Application Priority Data
Nov. 28, 2024 (DE) 10 2024 211 392.1

(51) Int. Cl. B60T 13/58; B60T 7/04; B60T 7/12; B60T 8/172; B60T 13/14; B60T 13/68; B60T 13/74; B60T 17/22

(52) U.S. Cl. CPC B60T 13/588; B60T 8/172; B60T 13/148; B60T 13/686; B60T 13/745; B60T 13/746; B60T 17/22; B60T 7/042; B60T 7/12; B60T 2220/04; B60T 2270/402; B60T 2270/404; B60T 2270/413; B60T 2270/82

(57) ABSTRACT

An electrohydraulic braking system, including a first hydraulic pressure source, inlet valves and outlet valves, at least two hydraulic wheel brakes and at least two electromechanical wheel brakes. A control unit is configured for controlling the at least two hydraulically actuatable wheel brakes and the at least two electromechanically actuatable wheel brakes, It is sought to provide a braking system with greater fail-safety. For this purpose, the braking system comprises a second electrically controllable hydraulic pressure source, and in each pressure supply line between the first pressure source and a respective one of the inlet valves there is only one respective circuit separation valve and no further valve. In this way, reliability against failures can be significantly increased without unnecessarily increasing the complexity and weight of the braking system.

### CROSS REFERENCE TO RELATED APPLICATIONS

This application claims priority to German Application No. 10 2024 211 392.1, filed Nov. 28, 2024, the contents of such application being incorporated by reference herein.

### FIELD OF THE INVENTION

The present invention relates to an electrohydraulic braking system, comprising a first electrically actuatable hydraulic pressure source, preferably a linear pressure generator, a respective inlet valve and an outlet valve for the connection of at least two hydraulically actuatable wheel brakes, at least one braking circuit which is configured for connecting at least one of the hydraulically actuatable wheel brakes, at least two electromechanically actuatable wheel brakes which are provided as service brakes, and at least one control unit which is configured to control the at least two hydraulically actuatable wheel brakes and the at least two electromechanically actuatable wheel brakes. The invention also relates to a control method for a braking system of this kind.

### BACKGROUND OF THE INVENTION

A braking system of the type mentioned above is known for example from DE 102012217825 A1, incorporated herein by reference. However, such a braking system has only limited fail-safe operation. This problem intensifies further if the hydraulic brake pedal is replaced by an electromechanical brake pedal, since the manual hydraulic fallback level is then eliminated.

In order to meet the requirements for highly automated driving (HAD=highly automated driving) from SAE Level 3 onwards, a fail-safe braking system is required. This means that, in the event of a first failure, the vehicle must still be capable of decelerating with a service braking power of at least −6.43 m/s² and ensuring the basic stability functions of the vehicle. Such systems also require a redundant power supply network in the vehicle. Many vehicle manufacturers are opting for a hybrid braking system (hydraulic and electromechanical wheel brakes) for future platforms in vehicle architecture in order to use the advantages in vehicle construction and take a first step towards dry braking technologies. In such hybrid braking systems, one wheel axle (preferably the front axle) uses a hydraulic braking system and the other wheel axle(s) (preferably rear wheel axle(s)) uses a dry braking system.

Known hybrid braking systems can often provide only a limited brake fluid volume per braking operation for a given first pressure source (in particular when a linear pressure generator is used) and are therefore not readily adaptable for every vehicle category, in particular to those with a high brake fluid volume requirement, such as heavy trucks.

Furthermore, in the case of a failure in one of the power supply networks that supplies the first pressure source, there is no longer any brake force boosting in the provided hydraulic fallback level. The remaining total deceleration in such a fault mode is often only provided by the manual hydraulic braking by the driver, for example at the front axle, and (depending on the connection of the electromechanical brakes to the power supply networks) often only by an electromechanical brake on the rear axle, for example. An architecture of this kind as in DE 102012217825 A1 partially no longer meets the requirements for highly automated driving and future highly redundant vehicle architectures in general. For example, deceleration >6.43 m/s² after the first failure, and slip control acting on the front wheels after the first failure, are expected, since this is already achievable with current fully hydraulic by-wire braking systems.

The same applies to electrical or mechanical failure of the first pressure source alone, since even then the braking force and functionality remaining through the fallback level are not sufficient.

Also in the event of a leakage failure and depending on the effects on the braking system, it is possible that the remaining braking power does not meet the latest requirements for failure operation of a deceleration >5 m/s² or, in the worst case, no braking power at all is available at the front wheels, and the rear wheels alone can barely meet the legal requirement of a deceleration of 2.44m/s².

At the same time, current fully hydraulic by-wire brake systems with high redundancy are complex, heavy and relatively expensive, and therefore direct implementation of known solutions for a semi-dry braking system would lead to an even more complex, heavier and more expensive overall system.

### SUMMARY OF THE INVENTION

An aspect_of the invention aims to provide a braking system of the type mentioned at the beginning which has improved reliability and performance in the event of a fault.

According to an aspect of the invention, this is achieved in a braking system of the type mentioned at the beginning in that the braking system comprises a second electrically controllable hydraulic pressure source, which is preferably a pump, and in that in each pressure supply line there is only one respective circuit separation valve and no further valve between the first pressure source and one of the respective inlet valves.

By means of this embodiment, on the one hand it is ensured that the first pressure source can be separated from all the braking circuits (whether one or more) and at the same time a second pressure source is provided which, in the event of failure of the first pressure source, can still provide brake force boosting and therefore a significantly higher overall deceleration and functionality even in the case of a simple system fault. At the same time, the number of valves is limited in order to keep the complexity, the weight and the total costs as low as possible.

In this document, service brakes are to be understood as meaning brakes which are primarily designed to decelerate the vehicle when traveling. They are thus not to be understood as brakes which function primarily as parking brakes or stationary brakes.

The braking system can comprise a manual brake pedal which can act on a hydraulic component of the braking system (e.g. a master cylinder) in order to provide a by-wire operating mode and a hydraulic fallback level depending on the switching position of a driver separation valve. The braking system can then also have a simulator and an associated driver pressure sensor on the master cylinder, which can be disconnected, together with the master cylinder, from the first and the second pressure source and the inlet valves by means of the driver separation valve (in the by-wire operating mode).

Alternatively, the braking system may be equipped with an electromechanical brake pedal which detects a braking request solely by means of pedal sensors, without the presence of a hydraulic connection.

A separate braking circuit and a circuit separation valve are preferably provided for each hydraulically actuatable wheel brake, which circuit separation valve is configured to disconnect the associated braking circuit with the associated wheel brake from the first pressure source. In this embodiment, functions such as wheel-specific brake pressure adaptation can additionally also be additionally implemented. Furthermore, in the event of a leakage or failure of a wheel valve (inlet valve, outlet valve) in a braking circuit, the corresponding braking circuit can be separated and braking can continue to be carried out on at least three wheel brakes (one wet, at least two dry) with full functionality and full brake pressure.

The second pressure source is preferably connected between at least one circuit separation valve and at least one inlet valve. This design ensures that in the event of a failure of the first pressure source or a leakage at or around the first pressure source, the affected components can be separated by closing the at least one circuit separation valve. The second pressure source then continues to permit the hydraulic wheel brakes to be supplied with brake force boosting, with the result that, even in the event of a simple fault in the braking system, a high maximum deceleration, which is considerably above the legal requirements, can still be provided.

In one embodiment, the second pressure source has two separate pressure-side connections, wherein in each case one of the pressure-side connections is connected to a respective one of the braking circuits. By means of this embodiment, it is for example possible for brake pressure to be provided to the two braking circuits in a wheel-specific manner. At the same time, it is still possible for a high braking force to be provided for at least one of the braking circuits even in the event of an even greater number of single or double faults since it is possible for the two braking circuits and hence the individual hydraulic wheel brakes to be separated from the first pressure source and the other braking circuit. “Pressure-side connections” should be understood here as meaning that these connections are arranged on the output side of the second pressure source, which supply hydraulic fluid at a pressure that is higher than the ambient pressure. This should be understood as opposed to one or more suction-side connections which are connected to a fluid reservoir or fluid reservoir chambers.

The first pressure source is preferably arranged in a first housing, and the second pressure source is preferably arranged in a second housing, wherein a check valve is arranged in the first housing in a pressure supply line from the second pressure source to at least one inlet valve, preferably wherein a respective check valve is arranged in the first housing in two pressure supply lines from the second pressure source to a respective braking circuit. This design makes it possible for the second housing to be configured in a relatively simple and compact manner and thus for both the total weight and the complexity of the braking system to be reduced. By virtue of the arrangement of the check valves in the first housing, reliable automatic sealing can be realized even in the event of a leakage in a connecting region of the first housing and the second housing.

The first housing and the second housing are preferably manufactured as valve blocks, for example from aluminum. The two housings may for example be screwed, wherein the hydraulic connecting points each have sealing elements. However, a peripheral seal may additionally also be provided between the first housing and the second housing.

Preferably, only the second pressure source and the associated check valves are arranged in the second housing. In particular, no fluid reservoirs or switchable valves or pressure sensors are arranged in the second housing. This allows a very compact and lightweight second housing.

It is preferred if the first pressure source is arranged in a first housing and the second pressure source is arranged in a second housing, wherein a check valve is arranged in the first housing and a check valve in the second housing is arranged along a pressure supply line from the second pressure source to at least one inlet valve, preferably wherein a respective check valve in the first housing and a respective check valve in the second housing are arranged along both pressure supply lines from the second pressure source to each of the inlet valves. Greater safety against leaks between the first housing and the second housing can be achieved in this way.

In one embodiment, the braking system comprises an electronic control unit with a first circuit board and a second circuit board, wherein the braking system is configured in such a way that the first pressure source can be controlled by the first circuit board and the second pressure source can be controlled by the second circuit board. This can further increase the fail-safe operation of the braking system, since a fault in one of the circuit boards does not lead to a complete loss of the brake boosting.

Preferably, the first circuit board and the second circuit board are arranged in galvanically isolated manner and/or in separate housings or housing portions. This measure further increases the fail-safety, since a fault in one of the circuit boards more rarely also affects the second circuit board. This can further increase the fail-safe operation of the braking system, since a fault in one of the circuit boards does not lead to a complete loss of the brake boosting and of the entire function of the braking system.

In one embodiment, the first pressure source is arranged in a first housing and the second pressure source is arranged in a second housing, wherein the second housing is fastened to the first housing in such a way that all hydraulic interfaces run directly between the first housing and the second housing through mutually adapted housing sides, so that hydraulic hoses or similar separate connecting lines can be dispensed with for these interfaces. With respect to a braking system with two housings (or valve blocks) which are to be installed separately, this embodiment reduces the installation effort in the vehicle. At the same time, some of the components can be dispensed with, whereby the overall weight and the costs are reduced.

It is preferred if an electronic control unit of the braking system is arranged in a control unit housing which is connected to the first housing, wherein a power supply and/or signal line is led from the control unit housing into the second housing to the second pressure source. The electric supply and/or signal line can be routed as a cable/cable arrangement from the control unit housing into the second housing, in particular if the control unit housing and the second housing cannot readily be arranged adjacently.

The first pressure source is preferably arranged in a first housing, and the second pressure source is preferably arranged in a second housing, wherein a first fluid reservoir or a first fluid reservoir chamber, which serves as a brake fluid source for the first pressure source, is arranged in the first housing, and wherein a second fluid reservoir or a second fluid reservoir chamber which serves as a brake fluid source for the second pressure source is arranged in the first housing. There is thus preferably no fluid reservoir arranged in the second housing. As a result, the second housing can be of relatively simple, lightweight and compact configuration, since the relatively bulky fluid reservoirs or fluid reservoir chambers are arranged in the first housing. Alternatively, the first fluid reservoir/fluid reservoir chamber and the second fluid reservoir/fluid reservoir chamber can also be arranged on an outer side of the first housing. It is also possible for a main reservoir (optionally with associated fluid reservoir chambers for the first pressure source and the second pressure source) to be fastened to the first housing, as an alternative to or in addition to two fluid reservoirs internal to the housing or two fluid reservoir chambers internal to the housing. By means of these solutions, it is possible for an adapted brake fluid volume to be provided for specific applications (e.g. small or heavy trucks).

In one embodiment, a pressure sensor for measuring a system pressure is arranged in only one of the two braking circuits. This embodiment reduces the costs, the weight and the complexity of the braking system. The hydraulic pressure in the other braking circuit may then be estimated, for example, from the measured pressure of the other braking circuit (and/or, if present, a brake pressure measured at the master cylinder by means of a driver pressure sensor).

Particularly preferably, the first pressure source is connected to a first energy source and the second pressure source is connected to a second energy source. This embodiment increases the fail-safe nature of the braking system.

In the present text, “energy source” can refer for example to an electrical network of the connected vehicle, in particular comprising an energy store (such as an accumulator) and a generator (such as an electric motor operated as a generator). It is thus possible, for example, for two power networks to be provided as redundant energy sources.

Preferably, the first circuit board is connected to a first energy source and the second circuit board is connected to a second energy source. This embodiment also increases the fail-safe nature of the braking system.

Preferably, a separate connection arrangement for connecting an energy source and/or for connecting signals is provided for each circuit board. This increases the fail-safe level since, even in the case of a separate power source/signal connection, the use of a common connection arrangement leaves the chance of a simultaneous power or signal failure in both boards nevertheless occurring (e.g. if a common connector plug detaches or is defective).

According to an aspect of the invention, a control method for a braking system according to any one of the above embodiments is also provided, comprising an electronic control unit, characterized in that, during a braking process, the control unit at least temporarily activates the first pressure source and the second pressure source to provide or adapt at least one brake pressure of the wheel brakes. In this way, it is possible for example for a larger brake fluid volume or wheel-specific brake pressures to be provided.

In one embodiment, the second pressure source is connected to both braking circuits, wherein the first pressure source is a linear pressure generator, and wherein the following steps are carried out for the wheel-specific brake pressure setting:
closing one of the two circuit separation valves and keeping the other of the two circuit separation valves open,
providing a high brake pressure by means of the second pressure source to both braking circuits,
reducing the brake pressure in the braking circuit with the circuit separation valve open, by throttling back the linear pressure generator.

This allows improved functions for vehicle stability control, since wheel-specific brake pressure control can be performed not only via the inlet valves of the wheel brakes but also via different brake pressure levels for wheel brakes of the same axle. Thus, in the case of so-called “wheel-individual blending”, an increased brake pressure for a wheel brake can also be achieved.

In one embodiment, the control method comprises the steps of:
receiving a brake request signal in the control unit,
calculating, by means of the control unit, the brake pressure required to implement the braking request, and
if the control unit determines that a higher brake pressure is required than the first pressure source or the second pressure source alone can provide at this time:
simultaneously activating the first pressure source and the second pressure source in order to jointly provide the calculated brake pressure. By means of such a tandem activation, a high brake pressure can be provided particularly quickly.

Another embodiment of the method comprises the steps of:
receiving a brake request signal in the control unit,
calculating, by means of the control unit, the brake pressure required to implement the braking request, and
if the control unit determines that a higher brake pressure is required than the first pressure source or the second pressure source alone can provide at this time:
building up a brake pressure up to a first brake pressure level by activating the first pressure source,
upon reaching the first brake pressure level, closing a circuit separation valve,
activating the second pressure source in order to increase the brake pressure from the first brake pressure level to a higher, second brake pressure level in one of the braking circuits. A high brake pressure can also be achieved by means of this method. Here, the sequential build-up of the brake pressure allows, for example, if the first pressure source is a linear pressure generator, to throttle back the first pressure source for refilling, while the second pressure wave maintains the brake pressure.

Further details of aspects of the invention are set forth in the description of the illustrated exemplary embodiments and in the appended claims.

### BRIEF DESCRIPTION OF THE DRAWINGS

In particular:

FIG. 1 shows a hydraulic circuit diagram of a first embodiment of a braking system according to the invention,

FIG. 2 shows a hydraulic circuit diagram of a second embodiment of a braking system according to the invention,

FIG. 3 shows a hydraulic circuit diagram of a third embodiment of a braking system according to the invention,

FIG. 4 shows a fourth embodiment of a braking system according to the invention,

FIG. 5 shows a fifth embodiment of a braking system according to the invention,

FIG. 6 shows a sixth embodiment of a braking system according to the invention,

FIG. 7 shows a seventh embodiment of a braking system according to the invention, and

FIG. 8 shows an eighth embodiment of a braking system according to the invention.

### DETAILED DESCRIPTION OF EXEMPLARY EMBODIMENTS

In the following detailed description of preferred embodiments, identical reference signs denote substantially same or identical parts in or on these embodiments. To better illustrate aspects of the invention, the preferred embodiments illustrated in the figures are however not always illustrated to scale.

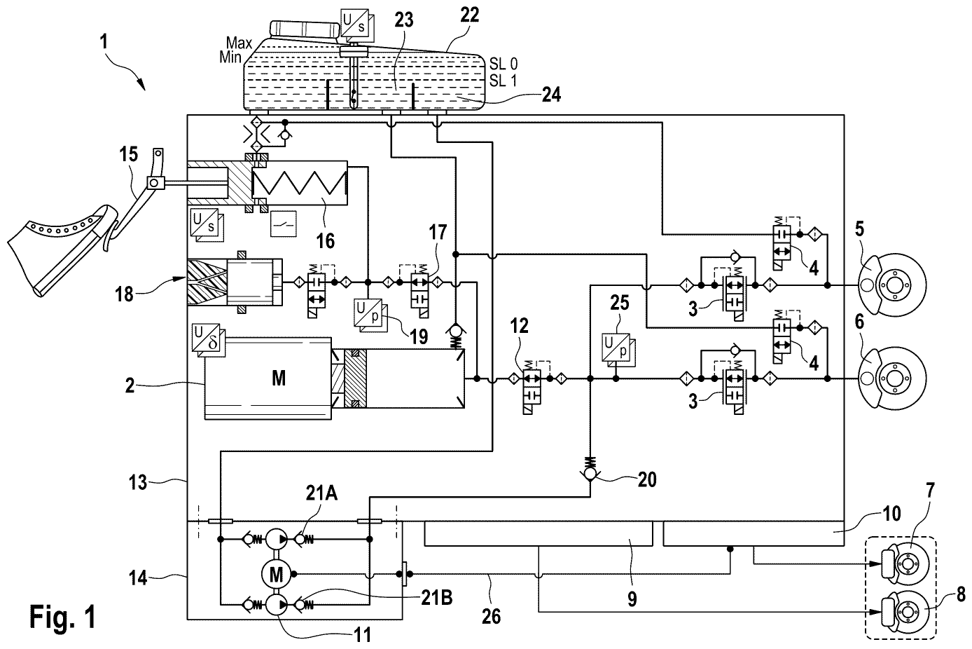

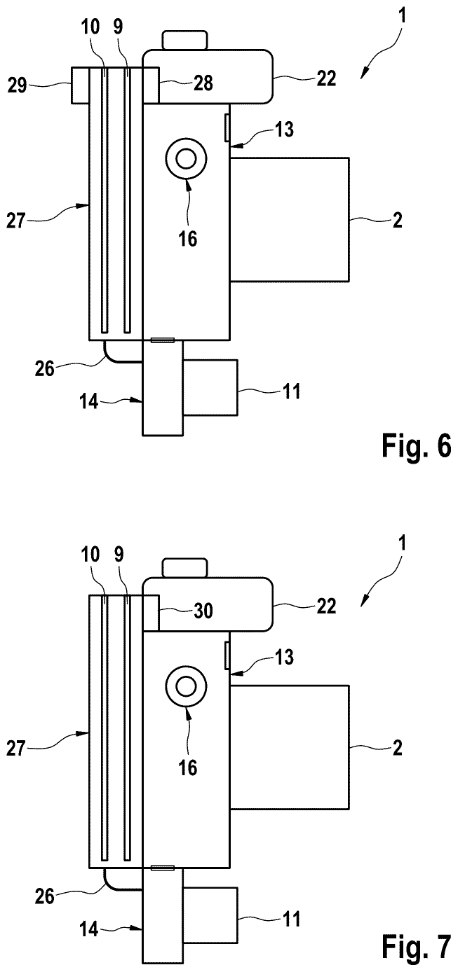

FIGS. 1 to 3 show hydraulic circuit diagrams of three embodiments of an electrohydraulic braking system 1 according to the invention. FIGS. 5 to 8 show schematic illustrations of five further embodiments of the electrohydraulic braking system 1 according to the invention, which can partially correspond to the embodiments in FIGS. 1 to 3.

As illustrated in FIG. 1, the electrohydraulic braking system 1 comprises a first electrically actuatable hydraulic pressure source 2, which in this case is a linear pressure generator by way of example. Furthermore, in each case one inlet valve 3 and one outlet valve 4 are provided for the connection of two hydraulically actuatable wheel brakes 5, 6. Here, the braking system 1 comprises a hydraulic braking circuit which is configured for connecting the two hydraulically actuatable wheel brakes 5, 6. The braking system 1 also comprises two electromechanically actuatable wheel brakes 7, 8 which are designed as service brakes (i.e. not pure parking brakes).

Furthermore, a control unit 9, 10 is provided which is configured to control the two hydraulically actuatable wheel brakes 5, 6 and the at least two electromechanically actuatable wheel brakes 7, 8. In the illustrated embodiments, the control unit 9, 10 comprises a first circuit board 9 and a second circuit board 10. Alternatively, however, it is also possible for only one control unit or two (for example spatially separated) control units to be provided.

Here, the first pressure source 2 can be controlled by the first circuit board 9 and the second pressure source 11 can be controlled by the second circuit board 10. This can further increase the fail-safe operation of the braking system, since a fault in one of the circuit boards 9, 10 does not lead to a complete loss of the brake boosting. The inlet valves 3 may be controllable by the first circuit board 9 and the outlet valves 4 may be controllable by the second circuit board 10.

The first pressure source 2 is connected to a first energy source and the second pressure source is connected to a second energy source (in each case not explicitly illustrated). The first circuit board 9 is connected to a first energy source and the second circuit board 10 is connected to a second energy source. One of the electromechanically actuatable wheel brakes 8 can be connected to the first energy source and the other of the electromechanically actuatable wheel brakes 7 can be connected to the second energy source.

The braking system 1 comprises a second electrically controllable hydraulic pressure source 11, which is embodied here as a pump. A circuit separation valve 12 and no further valve is arranged in each pressure supply line between the first pressure source 2 and a respective one of the inlet valves 3. The first pressure source 2 is arranged in a first housing 13, and the second pressure source 11 is arranged in a second housing 14. The second pressure source 11 is a two-piston pump here, the two pressure-side outputs of which are combined before it is routed as a line from the second housing 14 into the first housing 13.

The braking system 1 comprises, in the embodiments in FIGS. 1 and 2, 6, 7 and 8, a manual brake pedal 15 which can act on a master cylinder 16 in order to provide a by-wire operating mode and a hydraulic fallback level depending on the switching position of a driver separation valve 17. The braking system 1 may then also have a simulator 18, an associated driver pressure sensor 19 on the master cylinder 16, which can be separated from the pressure sources 2, 11 and the inlet valves 3 by means of the driver separation valve 17 (in the by-wire operating mode).

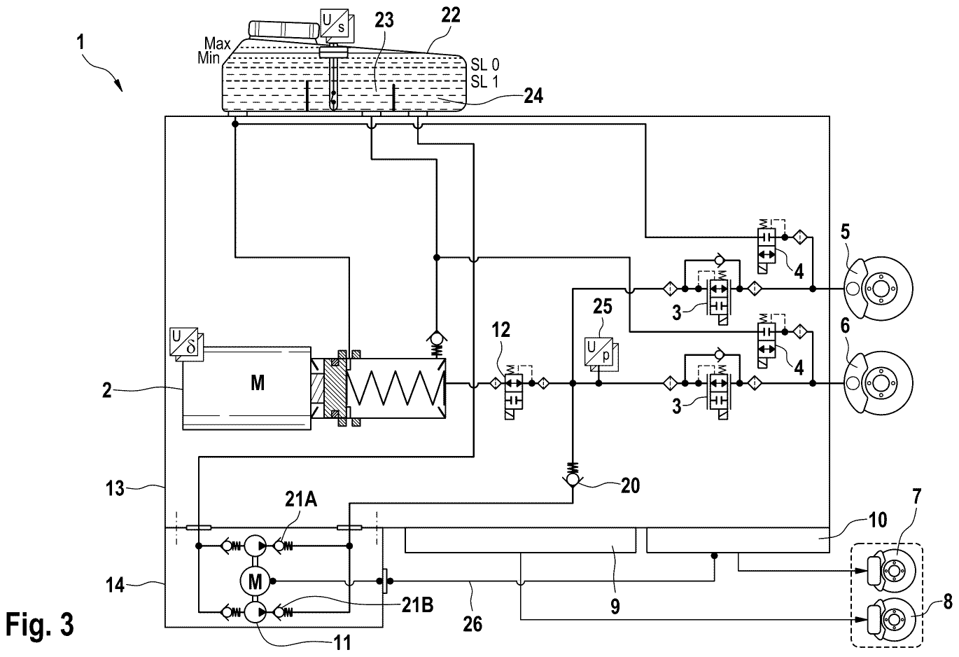

Alternatively, the braking system 1 may be equipped with an electromechanical brake pedal which detects a braking request by means of pedal sensors, without having a hydraulic connection, as is the case in FIGS. 3, 4 and 5 (the brake pedal is not explicitly illustrated there).

In the embodiments in FIGS. 1 and 3, the second pressure source 11 is connected between the circuit separation valve 12 and the inlet valves 3. This design ensures that in the event of a failure of the first pressure source 2 or a leakage at or around the first pressure source 2, the affected components can be separated by closing the circuit separation valve 12. The second pressure source 11 then continues to allow a supply to the hydraulic wheel brakes 5, 6.

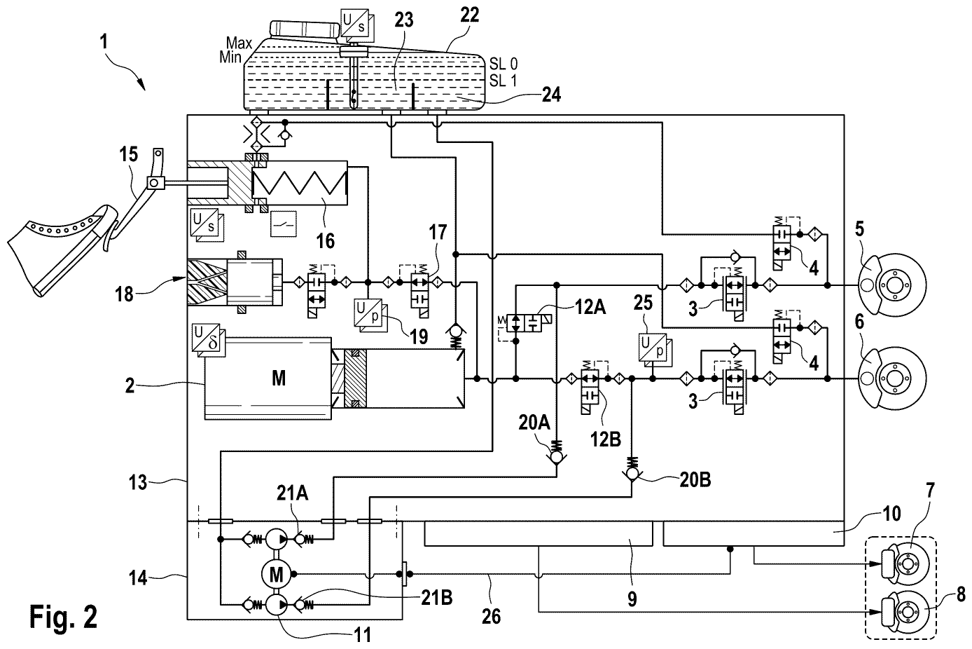

A separate braking circuit and a circuit separation valve 12A, 12B are provided for each hydraulically actuatable wheel brake 5, 6 in FIG. 2, which circuit separation valve is configured to disconnect the associated braking circuit with the associated wheel brake 5, 6 from the first pressure source 2. By means of this embodiment, it is for example possible for brake pressure to be provided to the two braking circuits with a respective wheel brake 5, 6 in a wheel-specific manner. At the same time, it is still possible for a high braking force to be provided for at least one of the braking circuits even in more situations with single or double faults in the braking system 1, since it is possible for the two braking circuits and hence the individual hydraulic wheel brakes to be separated from the first pressure source 2 and the respective other braking circuit.

In the embodiments in FIGS. 1 and 3, a check valve 20 is arranged in the first housing 13 in the one pressure supply line from the second pressure source 11 to at least one inlet valve 3. In the embodiment in FIG. 2, a respective check valve 20A, 20B is arranged in the first housing 13 in two pressure supply lines from the second pressure source 11 to a respective braking circuit. In all three embodiments in FIGS. 1 to 3, further check valves 21A, 21B are additionally also arranged in the second housing 14 at the two separate pressure-side connections of the second pressure source 11. This design makes it possible for the second housing 14 to be configured in a relatively simple and compact manner and thus for both the total weight and the complexity of the braking system 1 to be reduced. By virtue of arranging the check valves 20, 20A, 20B in the first housing 13 and the check valves 21A, 21B in the second housing 14, it is possible to realize reliable automatic sealing even in the event of a leakage in the connection region of the first housing 13 and the second housing 14.

FIGS. 1 to 4 and 6 to 8 show embodiments in which a main fluid reservoir 22 is fastened to an outer side of the first housing 13. The main fluid reservoir 22 comprises a first fluid reservoir chamber 23, which is connected to the first pressure source 2. The main fluid reservoir 22 comprises a second fluid reservoir chamber 24, which is connected to the second pressure source 11. However, the main fluid reservoir 22 can also alternatively be integrated into the first housing 13. The main fluid reservoir 22 may also be formed separately, with hydraulic connections to the first housing 13, as illustrated in FIG. 5. It is however also possible for one or more additional fluid reservoirs or fluid reservoir chambers to be arranged in the first housing 13 in addition to the main fluid reservoir 22.

In the embodiments shown in FIGS. 1 to 3, a pressure sensor 25 for measuring a system pressure is arranged in only one braking circuit. This embodiment reduces the costs, the weight and the complexity of the braking system. The hydraulic pressure in the other braking circuit (FIG. 2) can then be estimated, for example, from the measured pressure at the pressure sensor 25 and/or, if present (FIGS. 1, 2), from the brake pressure measured at the driver pressure sensor 19.

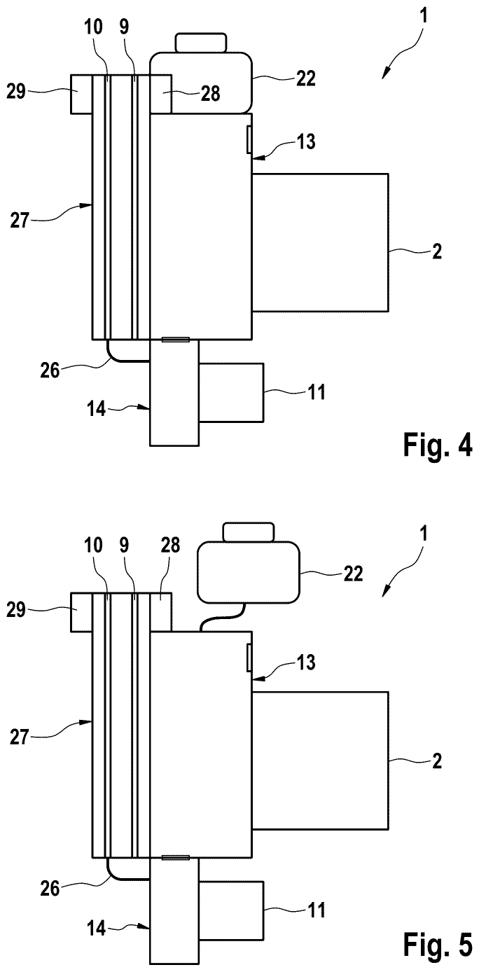

FIGS. 4 to 8 show schematic external views of various embodiments of the braking system 1 according to the invention and of the connection between the first housing 13 and the second housing 14. The electronic control unit 9, 10 of the braking system is arranged in each case in a control unit housing 27 which is connected to the first housing 13.

According to the embodiments in FIGS. 1 to 7, a power supply and/or signal line 26 is routed from the control unit housing 27 into the second housing 14 to the second pressure source 11. The electric supply and/or signal line 26 can be routed as a cable/cable arrangement from the control unit housing 27 into the second housing 14 on the outside, in particular if the control unit housing 27 and the second housing 14 cannot readily be arranged adjacently. The second pressure source 11 is preferably connected by means of a power supply and/or signal line 26 from the second housing 14 to the first housing 13 or to the second circuit board 10.

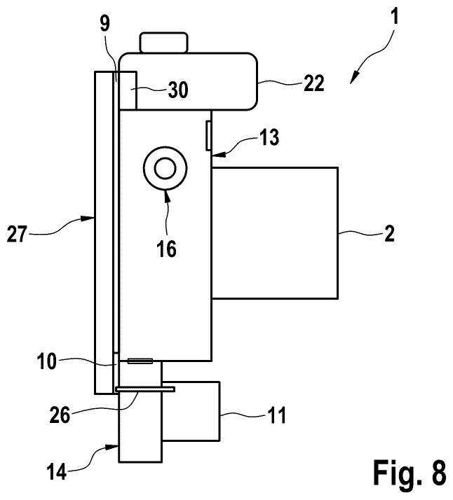

As illustrated in FIG. 8, the power supply and/or signal line 26 can also alternatively be routed within the housing from the second circuit board 10 to the second pressure source 11 with the control unit housing 27 and second housing 14 adjoining.

As illustrated in FIGS. 4, 5 and 6, a separate connection arrangement 28, 29 for power supply and/or signal connection can be provided for each circuit board 9, 10. As an alternative, as in FIGS. 7 and 8, a common connection arrangement 30 can be provided for supplying power and/or for signal connection. The common connection arrangement 30 can however nevertheless comprise separate power supply connections or separate signal connections for the circuit board 9 and the circuit board 10.

As can be seen in FIGS. 4 to 8, the first housing 13 and the second housing 14 can preferably be manufactured as valve blocks, for example made of aluminum. The two housings 13, 14 may for example be screwed, wherein the hydraulic connecting points each have sealing elements. However, a peripheral seal may additionally also be provided between the first housing 13 and the second housing 14. As indicated, the second housing 14 may be considerably smaller than the first housing 13 because as many components of the braking system 1 as possible are arranged in the first housing 13.

### LIST OF REFERENCE NUMERALS

1 braking system
2 first pressure source
3 inlet valve
4 outlet valve
5 hydraulically actuatable wheel brake
6 hydraulically actuatable wheel brake
7 electromechanically actuatable wheel brake
8 electromechanically actuatable wheel brake
9 first circuit board/electronic control unit
10 second circuit board/electronic control unit
11 second pressure source
12 circuit separation valve
12A circuit separation valve
12B circuit separation valve
13 first housing
14 second housing
15 manual brake pedal
16 master cylinder
17 driver separation valve
18 simulator
19 driver pressure sensor
20 check valve
20A check valve
20B check valve
21A check valve
21B check valve
22 main fluid reservoir
23 first fluid reservoir chamber
24 second fluid reservoir chamber
25 pressure sensor
26 power supply and/or signal line
27 control unit housing
28 separate connection arrangement
29 separate connection arrangement
30 common connection arrangement

1. An electrohydraulic braking system, comprising
a first electrically controllable hydraulic pressure source,
one respective inlet valve and one respective outlet valve for connecting at least two hydraulically actuatable wheel brakes,
at least one braking circuit which is configured for connecting at least one of the hydraulically actuatable wheel brakes,
at least two electromechanically actuatable wheel brakes, which are configured as service brakes,
at least one control unit, which is configured for controlling the at least two hydraulically actuatable wheel brakes, and the at least two electromechanically actuatable wheel brakes,
wherein the braking system comprises a second electrically controllable hydraulic pressure source,
and in that in each pressure supply line there is only one respective circuit separation valve and no further valve between the first pressure source and a respective one of the inlet valves.

2. The braking system according to claim 1, wherein a separate braking circuit and a circuit separation valve are provided for each hydraulically actuatable wheel brake, which circuit separation valve is configured to disconnect the associated braking circuit with the associated wheel brake, from the first pressure source.

3. The braking system according to claim 1, wherein the second pressure source is connected between at least one circuit separation valve and at least one inlet valve.

4. The braking system according to claim 2, wherein the second pressure source has two separate pressure-side connections, wherein in each case one of the pressure-side connections is connected to a respective one of the braking circuits.

5. The braking system according to claim 1, wherein the first pressure source is arranged in a first housing, and the second pressure source is arranged in a second housing, wherein a check valve is arranged in the first housing in a pressure supply line from the second pressure source to at least one inlet valve, wherein a respective check valve is arranged in the first housing in two pressure supply lines from the second pressure source to a respective braking circuit.

6. The braking system according to claim 1, wherein the first pressure source is arranged in a first housing and the second pressure source is arranged in a second housing, wherein a check valve is arranged in the first housing and a check valve is arranged in the second housing along a pressure supply line from the second pressure source to at least one inlet valve, wherein a respective check valve in the first housing and a respective check valve in the second housing are arranged along both pressure supply lines from the second pressure source to each of the inlet valves.

7. The braking system according to claim 1, wherein the braking system comprises an electronic control unit with a first circuit board and a second circuit board, wherein the braking system is configured in such a way that the first pressure source can be controlled by the first circuit board and the second pressure source can be controlled by the second circuit board.

8. The braking system according to claim 7, wherein the first circuit board and the second circuit board are galvanically separated and/or arranged in separate housings or housing portions.

9. The braking system according to claim 1, wherein the first pressure source is arranged in a first housing, and the second pressure source is arranged in a second housing, wherein the second housing is fastened to the first housing in such a way that all hydraulic interfaces run directly between the first housing and the second housing through mutually adapted housing sides, such that hydraulic hoses or similar separate connecting lines can be dispensed with for these interfaces.

10. The braking system according to claim 9, wherein an electronic control unit of the braking system is arranged in a control unit housing which is connected to the first housing, wherein a power supply and/or signal line is led from the control unit housing into the second housing to the second pressure source.

11. The braking system according to claim 1, wherein the first pressure source is arranged in a first housing, and the second pressure source is arranged in a second housing,
wherein a first fluid reservoir or a first fluid reservoir chamber is arranged in the first housing, which serves as a brake fluid source for the first pressure source,
and wherein a second fluid reservoir or a second fluid reservoir chamber is arranged in the first housing, which serves as a brake fluid source for the second pressure source.

12. The braking system according to claim 2, wherein a pressure sensor for measuring a system pressure is arranged in only one of the two braking circuits.

13. The braking system according to claim 1, wherein the first pressure source is connected to a first energy source and the second pressure source is connected to a second energy source.

14. The braking system according to claim 7, wherein the first circuit board is connected to a first energy source and the second circuit board is connected to a second energy source.

15. The braking system according to claim 7, wherein a separate connection arrangement for connecting an energy source and/or for connecting signals is provided for each circuit board 9, 10.

16. A control method for a braking system according to claim 1, comprising an electronic control unit, wherein
the control unit activates the first pressure source and the second pressure source at least temporarily during a braking process to provide or adapt at least one brake pressure of the wheel brakes.

17. The control method according to claim 16, wherein the second pressure source is connected to both braking circuits, wherein the first pressure source is a linear pressure generator, and wherein the following steps are carried out for the wheel-specific brake pressure setting:
closing one of the two circuit separation valves and keeping the other of the two circuit separation valves open,
providing a high brake pressure by the second pressure source to both braking circuits,
reducing the brake pressure in the braking circuit with the circuit separation valve open, by throttling back the linear pressure generator.

18. The control method according to claim 16, comprising:
receiving a brake request signal in the control unit,
calculating, by the control unit the brake pressure required to implement the brake request, and
if the control unit determines that a higher brake pressure is required than the first pressure source or the second pressure source alone can provide at this time:
simultaneously activating the first pressure source and the second pressure source in order to jointly provide the calculated brake pressure.

19. The control method according to claim 16, further comprising:
receiving a brake request signal in the control unit,
calculating, by the control unit, the brake pressure required to implement the braking request, and
if the control unit, determines that a higher brake pressure is required than the first pressure source or the second pressure source alone can provide at this time:
building up a brake pressure up to a first brake pressure level by activating the first pressure source,
upon reaching the first brake pressure level, closing a circuit separation valve,
activating the second pressure source in order to increase the brake pressure from the first brake pressure level to a higher, second brake pressure level in one of the braking circuits.

20. The braking system according to claim 1, wherein the first electrically controllable hydraulic pressure source is a linear pressure generator, and the second electrically controllable hydraulic pressure source is a pump.
